(19) United States
(12) Patent Application Publication
(10) Pub. No.: US 2015/0267913 A1
(43) Pub. Date: Sep. 24, 2015

(54) GLOW CUP

(71) Applicant: Group JDS, Hong Kong (CN)

(72) Inventor: Jeffrey D. Schrimmer, Highland Park, IL (US)

(73) Assignee: Group JDS, Hong Kong (CN)

(21) Appl. No.: 14/188,177

(22) Filed: Feb. 24, 2014

(51) Int. Cl. F21V 33/00; A47G 19/22; F21K 2/06

(52) U.S. Cl. CPC F21V 33/0036; F21K 2/06; A47G 19/2205

(57) ABSTRACT

A glow cup includes a liquid container defined at least in part by a cup bottom and a cup sidewall. An illumination member receptacle is positioned at least partially within the liquid container and has a receptacle opening corresponding with an opening through the liquid container. At least one retention feature extends inwardly from an interior surface of the illumination member receptacle. The glow cup has a configuration in which an illumination member is retained within the illumination member receptacle using an interference fit between the illumination member and the retention feature.

### TECHNICAL FIELD

The present disclosure relates generally to a glow cup, and more particularly to a liquid container including or supporting a source of light.

### BACKGROUND

Glow cups are beverage containers incorporating a source of light, such as, for example, a battery-powered light-emitting diode (LED) or a chemiluminescent device, such as a chemical glow stick. Glow cups are typically provided for one-time use at a party or other event and, thus, are often characterized as novelty items. According to one example, U.S. Pat. No. 4,563,726 to Newcomb et al. teaches an illuminated chemiluminescent drinking mug. The drinking mug includes an axially disposed tube attached integrally to the bottom of the mug. The tube is closed at its upper end and open at its lower end, and is adapted to receive a light stick. A plug is secured in the open end of the tube to maintain the light stick within the tube.

As with most novelty items, there is a continuing need to design glow cups that are both popular with consumers and also inexpensive to mass produce and distribute. The present disclosure is directed to such an effort, which includes designing glow cups having advantages over conventional glow cups.

### SUMMARY OF THE DISCLOSURE

In one aspect, a glow cup includes a liquid container defined at least in part by a cup bottom and a cup sidewall. An illumination member receptacle is positioned at least partially within the liquid container and has a receptacle opening corresponding with an opening through the liquid container. At least one retention feature extends inwardly from an interior surface of the illumination member receptacle. The glow cup has a configuration in which an illumination member is retained within the illumination member receptacle using an interference fit between the illumination member and the retention feature.

In another aspect, a glow cup system includes a liquid container defined at least in part by a cup bottom and a cup sidewall, an illumination member receptacle supported within the liquid container and having a receptacle open end aligned with an opening through one of the cup bottom and the cup sidewall, and an illumination member. The glow cup system has a configuration in which the illumination member is retained within the illumination member receptacle using an interference fit.

In another aspect, a set of glow cups includes a first glow cup and a second glow cup. The first glow cup includes a first liquid container defined at least in part by a first cup bottom and a first cup sidewall, and a first illumination member receptacle secured within the first liquid container and having a first receptacle open end aligned with a first opening through one of the first cup bottom and the first cup sidewall. The second glow cup includes a second liquid container defined at least in part by a second cup bottom and a second cup sidewall, and a second illumination member receptacle secured within the second liquid container and having a second receptacle open end aligned with a second opening through one of the second cup bottom and the second cup sidewall. The set of glow cups has a stacked configuration in which the second glow cup is overlappingly received within the first glow cup.

### BRIEF DESCRIPTION OF THE DRAWINGS

FIG. 1 is a perspective view of an exemplary glow cup, according to the present disclosure;

FIG. 2 is a cross section of the exemplary glow cup, taken along lines 2-2 of FIG. 1;

FIG. 3 is a side diagrammatic view of an exemplary illumination member sized for use with the exemplary glow cup of FIGS. 1 and 2;

FIG. 4 is a perspective view of the exemplary glow cup of FIGS. 1 and 2, shown according to a configuration in which the illumination member of FIG. 3 is retained within the illumination member receptacle using an interference fit; and

FIG. 5 is a perspective view of a set of glow cups, shown in a stacked configuration in which a second glow cup is overlappingly received within a first glow cup.

### DETAILED DESCRIPTION

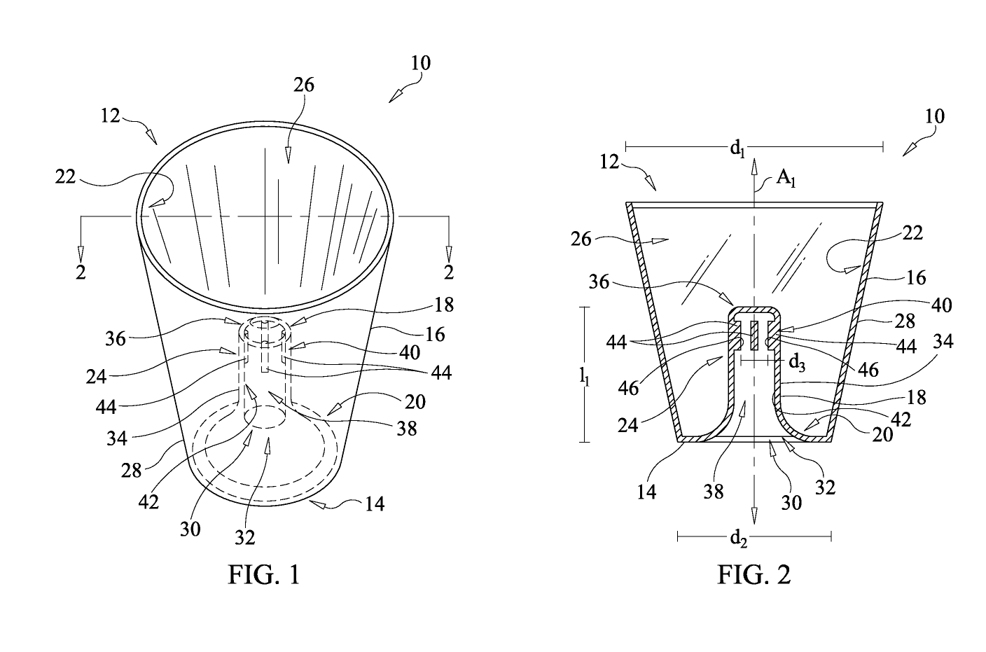

FIG. 1 depicts an exemplary embodiment of a glow cup 10 according to the present disclosure. The glow cup 10 includes a liquid container 12 defined at least in part by a cup bottom 14 and a cup sidewall 16. The liquid container 12 also includes an illumination member receptacle 18. According to the exemplary embodiment, the illumination member receptacle 18, which will be described below in greater detail, is supported by and positioned within the liquid container 12. Further, according to the exemplary embodiment, the illumination member receptacle 18 is integral with the cup bottom 14 and also defines a portion of the liquid container 12. In particular, an interior surface 20 of the cup bottom 14, an interior surface 22 of the cup sidewall 16, and an exterior surface 24 of the illumination member receptacle 18 together define an interior space 26 of the liquid container 12 suitable for receiving a liquid, such as a beverage.

As shown, the cup sidewall 16 may be substantially cylindrical, or circular, in shape. In addition, and with reference now to the cross-sectional view of FIG. 2, the cup sidewall 16 may be tapered toward the cup bottom 14. That is, an upper diameter d₁ of the glow cup 10 may be greater than a lower diameter d₂ of the glow cup 10. Although not required, the cup bottom 14, cup sidewall 16, and illumination member receptacle 18 may be a unitary one-piece structure 28. For example, the glow cup 10 may be a single, molded polypropylene structure that includes the cup bottom 14, cup sidewall 16, and illumination member receptacle 18. However, it should be appreciated that materials, dimensions, shapes, and configurations of the glow cup 10 may vary depending on preferences, costs, manufacturing constraints, and other considerations.

The illumination member receptacle 18 may have a receptacle opening, or receptacle open end, 30 aligned with an opening 32 through one of the cup bottom 14 and the cup sidewall 16. According to the exemplary embodiment, and with continued reference to FIG. 2, the receptacle open end 30 aligns with the opening 32 through the cup bottom 14. More particularly, and according to the present embodiment, the receptacle open end 30 may define the opening 32 through the cup bottom 14, and vice versa. The illumination member receptacle 18 may have an oblong body 34 including a closed end 36 and the receptacle open end 30. The oblong body 34 may be oriented along a central vertical axis Aₗ through the glow cup 10 such that the illumination member receptacle 18 and liquid container 12, or cup sidewall 16, may be concentric.

As stated above, the illumination member receptacle 18 may be integral with the cup bottom 14, and an interior 38 of the illumination member receptacle 18 may be fluidly isolated with respect to the interior space 26 of the glow cup 10. That is, the glow cup 10 should be capable of retaining a liquid therein, without significant leakage. Further, it may be desirable to reduce leakage of a liquid contained within the glow cup 10 into the illumination member receptacle 18. Thus, according to embodiments utilizing one or more separate components to define the unitary one-piece structure 28, appropriate attachments and sealing members may be required.

The interior 38 of the illumination member receptacle 18, as defined by the oblong body 34, may have a length l₁, which may be varied for alternative embodiments contemplated herein. The illumination member receptacle 18 also includes at least one retention feature 40 extending inwardly from an interior surface 42 of the illumination member receptacle 18. According to the exemplary glow cup 10, the interior surface 42 of the illumination member receptacle 18 includes a set of inwardly extending projections 44. The set of inwardly extending projections 44 may or may not be integral with the illumination member receptacle 18, may include any desired number of projections 44, and may be positioned and spaced to provide suitable retention, as will be described below. Free ends 46, or innermost ends, or edges of the projections 44 may define a diameter d₃, sized appropriately to receive and retain an illumination member.

Various alternative embodiments, still within the scope of the present disclosure, are also contemplated. For example, the illumination member receptacle 18 may be offset from the central vertical axis A₁ by any amount and, further, may even be partially integrated with the cup sidewall 16. According to some embodiments, the receptacle opening 30 may correspond with either or both of the cup sidewall 16 and the cup bottom 14, or even with the opening through the top of the liquid container 12. Thus, as should be appreciated, the illumination member receptacle 18 may have a vertical orientation, a horizontal orientation, or any orientation therebetween. Further, the illumination member receptacle 18 may form a partial enclosure, providing any desired amount of exposure. The type of retention feature 40 utilized may depend on the location, orientation, and configuration of the illumination member receptacle 18.

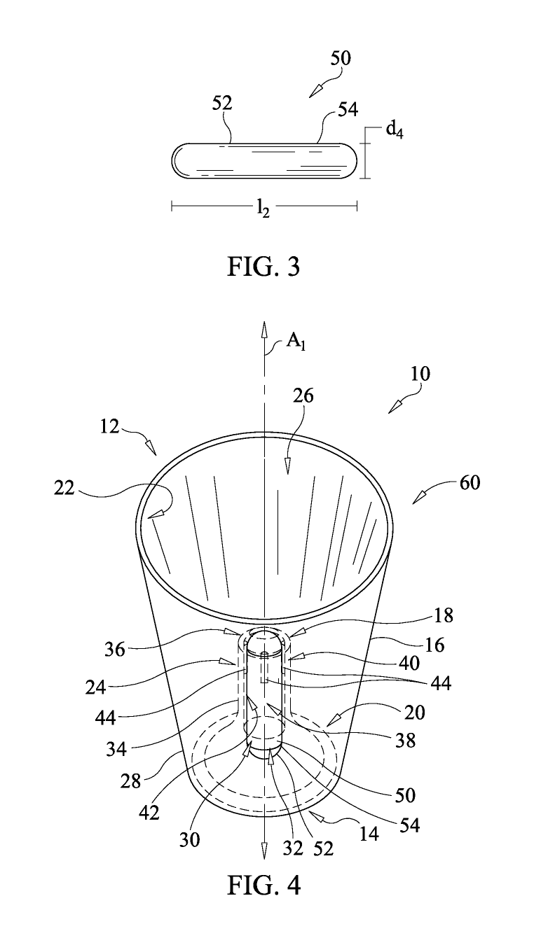

The glow cup 10 may be provided with or may be suitable for use with an illumination member 50, shown in FIG. 3, which may include a light-transmitting casing 52. The illumination member 50 may have a substantially oblong shape, as shown, or other suitable shape, and should be sized for receipt within the illumination member receptacle 18. The illumination member 50 may be or may include a glow stick 54, such as a chemi-luminescent device or chemical glow stick. Alternatively, the illumination member 50 may be, or may include, an LED device, or any additional and/or alternative light source configured for receipt within the illumination member receptacle 18, as described herein. Light sources, such as chemical glow sticks and LEDs are known and, therefore, will not be discussed herein in greater detail.

The illumination member 50 may have a diameter d₄ that matches or is slightly larger than the diameter d₃ defined by the free ends or edges 46 of the projections 44 such that the glow cup 10 includes a configuration, shown in FIG. 4, in which the illumination member 50 is retained within the illumination member receptacle 18 using an interference fit. More specifically, the set of inwardly extending projections 44 may provide the interference fit between the illumination member 50 and the illumination member receptacle 18. Although projections 44 are shown, it should be appreciated that alternative means for retaining the illumination member 50 within the illumination member receptacle 18 using an interference fit may be substituted for the projections 44. The interference fit maintains a stable, fixed position of the illumination member 50 relative to the glow cup 10, and doesn't require any components in addition to the glow cup 10 that may become damaged or misplaced.

The illumination member 50 may also have a length l₂ that is less than the length l₁ of the interior 38 of the illumination member receptacle 18 such that the illumination member 50, when retained according to the interference fit, does not project beyond the receptacle open end 30 and/or the opening 32 through the cup bottom 14. In combination, the illumination member 50 and the glow cup 10 may define a glow cup system 60. According to some embodiments, the glow cup 10 may be packaged and/or sold with one or more illumination members 50. The illumination member 50 may first be activated, or otherwise changed to an illuminated state, prior to inserting the illumination member 50 into the illumination member receptacle 18 through the cup bottom 14. To permit the light emitted from the illumination member 50 to be visible by the user, one or more of the illumination member receptacle 18, cup bottom 14, and cup sidewall 16 may be made from a light-transmitting material. For example, all or a majority of the glow cup 10 may be made from a transparent or translucent material, which may include plastic.

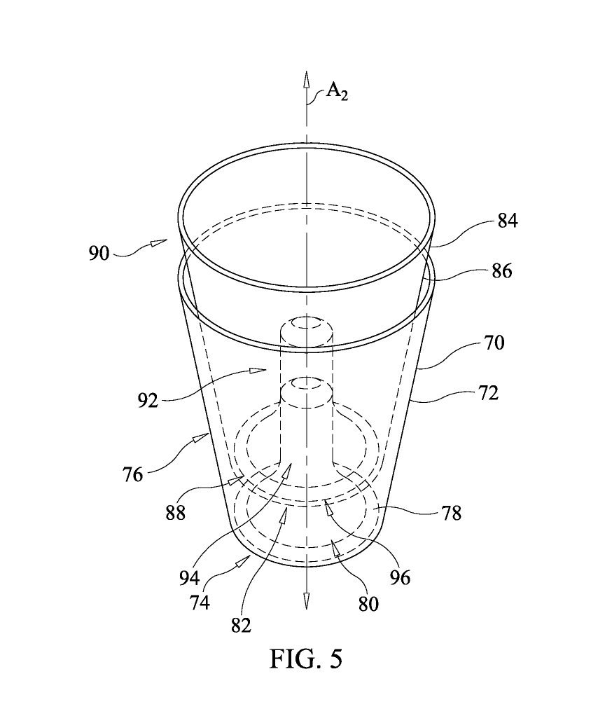

Turning now to FIG. 5, a set of glow cups, each similar to the glow cup 10 of FIGS. 1, 2, and 4, are shown in a stacked configuration. In particular, a first glow cup 70 includes a first liquid container 72 defined at least in part by a first cup bottom 74 and a first cup sidewall 76, and a first illumination member receptacle 78 secured within the first liquid container 72 and having a first receptacle open end 80 aligned with a first opening 82 through one of the first cup bottom 74 and the first cup sidewall 76. A second glow cup 84 includes a second liquid container 86 defined at least in part by a second cup bottom 88 and a second cup sidewall 90, and a second illumination member receptacle 92 secured within the second liquid container 86 and having a second receptacle open end 94 aligned with a second opening 96 through one of the second cup bottom 88 and the second cup sidewall 90.

The set of glow cups 70, 84, which may include more than just first and second glow cups 70, 84, are shown in a stacked configuration in which the second glow cup 84 is overlappingly received within the first glow cup 70. According to the exemplary embodiment, a portion of the first illumination member receptacle 78 is received within the second illumination member receptacle 92 in the stacked configuration. Also, in the stacked configuration, the first illumination member receptacle 78, the first cup sidewall 76, the second illumination member receptacle 92, and the second cup sidewall 90 are concentric, relative to a common central axis A₂. The amount, or degree, of tapering of the first and second cup sidewalls 76, 90 and/or the positioning and configuration of the first and second illumination member receptacles 78, 92 may be varied to provide the desired amount of overlapping. The ability to stack the first and second glow cups 70, 84 in an overlapping manner may improve packaging and distribution thereof and may provide a feature desirable to consumers. As an additional advantage of the overlapping capabilities, the first illumination member receptacle 78 of the first glow cup 70 may be used to assist in fully inserting an illumination member, such as illumination member 50, into the second illumination member receptacle 92.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A glow cup, comprising:
a liquid container defined at least in part by a cup bottom and a cup sidewall;
an illumination member receptacle positioned at least partially within the liquid container and having a receptacle opening corresponding with an opening through the liquid container; and
at least one retention feature extending inwardly from an interior surface of the illumination member receptacle;
wherein the glow cup has a configuration in which an illumination member is retained within the illumination member receptacle using an interference fit between the illumination member and the retention feature.

2. The glow cup of claim 1, wherein the cup sidewall is cylindrical.

3. The glow cup of claim 1, wherein the cup sidewall is tapered toward the cup bottom.

4. The glow cup of claim 1, wherein the receptacle opening is a receptacle open end aligned with the opening through one of the cup bottom and the cup sidewall.

5. The glow cup of claim 1, wherein the illumination member receptacle includes a light-transmitting material.

6. The glow cup of claim 5, wherein the cup sidewall and the cup bottom include the light-transmitting material.

7. The glow cup of claim 1, wherein the cup bottom, the cup sidewall, and the illumination member receptacle are a unitary one-piece structure.

8. The glow cup of claim 7, wherein the unitary one-piece structure includes polypropylene.

9. The glow cup of claim 4, wherein the receptacle open end aligns with the opening through the cup bottom.

10. The glow cup of claim 1, wherein the interior surface of the illumination member receptacle includes a set of inwardly extending projections.

11. A glow cup system, comprising:
a liquid container defined at least in part by a cup bottom and a cup sidewall;
an illumination member receptacle supported within the liquid container and having a receptacle open end aligned with an opening through one of the cup bottom and the cup sidewall;
an illumination member; and
wherein the glow cup system has a configuration in which the illumination member is retained within the illumination member receptacle using an interference fit.

12. The glow cup system of claim 11, wherein the illumination member is a glow stick.

13. The glow cup system of claim 12, wherein the cup sidewall is tapered toward the cup bottom.

14. The glow cup system of claim 13, wherein the illumination member receptacle includes a light-transmitting material.

15. The glow cup system of claim 14, wherein the illumination member receptacle is integral with the liquid container, and the receptacle open end aligns with the opening through the cup bottom.

16. The glow cup system of claim 15, wherein the illumination member receptacle and the cup sidewall are concentric.

17. The glow cup system of claim 16, wherein an interior surface of the illumination member receptacle includes a set of inwardly extending projections for providing the interference fit between the illumination member and the illumination member receptacle.

18. A set of glow cups, comprising:
a first glow cup including a first liquid container defined at least in part by a first cup bottom and a first cup sidewall, and a first illumination member receptacle secured within the first liquid container and having a first receptacle open end aligned with a first opening through one of the first cup bottom and the first cup sidewall; and
a second glow cup including a second liquid container defined at least in part by a second cup bottom and a second cup sidewall, and a second illumination member receptacle secured within the second liquid container and having a second receptacle open end aligned with a second opening through one of the second cup bottom and the second cup sidewall;
wherein the set of glow cups has a stacked configuration in which the second glow cup is overlappingly received within the first glow cup.

19. The sets of glow cups of claim 18, wherein, in the stacked configuration, the first illumination member receptacle, the first cup sidewall, the second illumination member receptacle, and the second cup sidewall are concentric.

20. The set of glow cups of claim 18, wherein, in the stacked configuration, a portion of the first illumination member receptacle is received within the second illumination member receptacle.
